(19) United States
(12) Patent Application Publication
(10) Pub. No.: US 2026/0251141 A1
(43) Pub. Date: Aug. 27, 2026

(54) DISPLACEMENT MACHINE ACCORDING TO THE SPIRAL PRINCIPLE

(71) Applicant: OET GMBH, Lustenau (AT)

(72) Inventors: Christian BUSCH, Feldkirch (AT); Roman LÄSSER, Wolfurt (AT)

(21) Appl. No.: 18/862,358

(22) PCT Filed: May 2, 2023
(86) PCT No.: PCT/EP2023/061458

§ 371 Date: Nov. 1, 2024

(30) Foreign Application Priority Data
May 6, 2022 (DE) 10 2022 111 378.7

(51) Int. Cl. F04C 15/00; F04C 2/02

(52) U.S. Cl. CPC F04C 15/008; F04C 2/025; F04C 2240/30; F04C 2240/50

(57) ABSTRACT

The invention relates to a displacement machine according to the spiral principle, in particular a scroll compressor, with a housing and a compression assembly, which has an electric motor, an orbiting displacement spiral, a counterspiral and a bearing plate, wherein the displacement spiral and the counterspiral intermesh in such a way as to form variable compression chambers between the displacement spiral and the counterspiral, so as to receive and compress a working fluid flowing through a working fluid circuit, and wherein the electric motor is drive-connected with the displacement spiral by means of a motor shaft. The invention is characterized in that the compression assembly is decoupled from the housing in terms of oscillation.

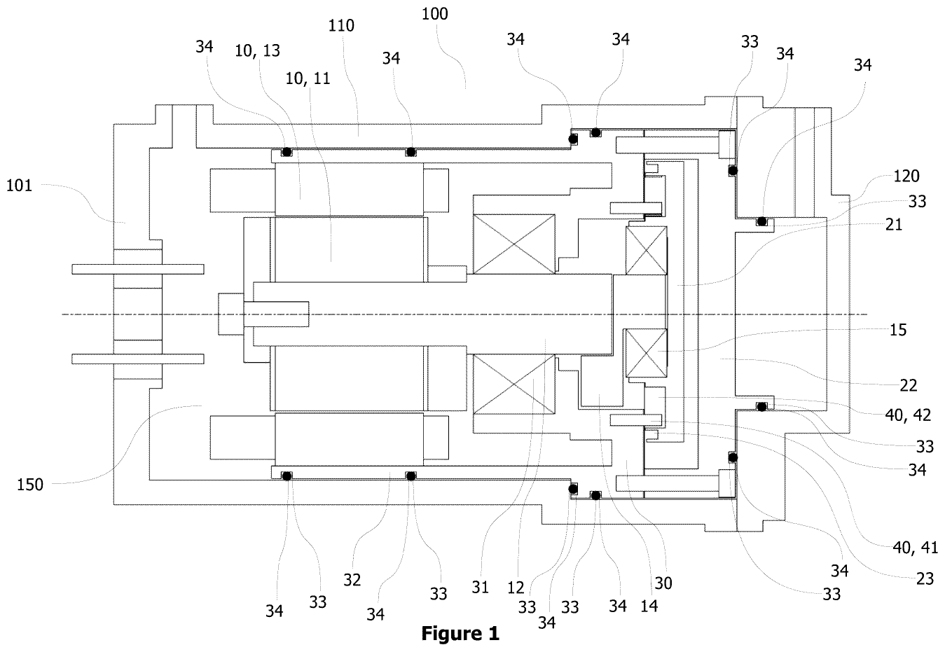

### CROSS-REFERENCE TO RELATED APPLICATIONS

This application is a National Stage Application of International Application No. PCT/EP2023/061458, filed on May 2, 2023, which claims benefit of priority to German Patent Application No. 102022111378.7, filed on May 6, 2022, which applications are incorporated herein by reference in their entirety. To the extent appropriate, a claim of priority is made to each of the above disclosed applications.

### TECHNICAL FIELD

The invention relates to a displacement machine according to the spiral principle, in particular a scroll compressor.

Displacement machines that operate according to the spiral principle, in particular scroll compressors, are known from practice. They are customarily used as compressors for air conditioning systems in vehicles. In general, these kinds of scroll compressors are designed in such a way that a compressor assembly having an electric motor, an orbiting displacement spiral, a counterspiral and a mounting plate is arranged in a housing. The housing is intended to protect the inner components of the scroll compressor against corrosion.

The operating principle of the scroll compressor involves having the compressor spiral and counterspiral intermesh, so that variable compression chambers are formed between the displacement spiral and the counterspiral. A working fluid flows into these compression chambers, and is compressed by the variable compression chambers. The orbiting displacement spiral is driven via the electric motor by means of a motor shaft, which is drive-connected with the displacement spiral.

Scroll compressors are generally very efficient and basically smooth running. However, the rising electrification of vehicles is significantly increasing the requirements for smooth running. In electrically driven vehicles, small vibrations in individual components already lead to a marked noise generation. In conventional vehicles with internal combustion engines, this type of noise generation is not noticeable due to the vibrations of the internal combustion engine. However, the vibrations emitted by the vehicle drive system are distinctly reduced in electrically driven vehicles by reducing moving parts. As a result, vibrations by other components in the vehicle come to the fore. For this reason, there is a high level of commitment to improve other moving components in a vehicle with respect to vibrations and sound emissions. This also relates in particular to air conditioning compressors in vehicles.

As a consequence, the object of the invention is therefore to provide a displacement machine according to the spiral principle, in particular a scroll compressor, which is improved with respect to vibrations and sound emissions.

The invention is thus based on the idea of providing a displacement machine according to the spiral principle, in particular a scroll compressor, with a housing and a compression assembly, wherein the compression assembly has an electric motor, an orbiting displacement spiral, a counterspiral and a bearing plate. The displacement spiral and the counterspiral intermesh in such a way as to form variable compression chambers between the displacement spiral and the counterspiral, so as to receive and compress a working fluid flowing through a working fluid circuit. According to the invention, the compression assembly is decoupled from the housing in terms of oscillation.

The invention is based on the idea of combining all movable elements of the displacement machine into a compression assembly, and decoupling this compression group from the housing of the displacement machine, so that oscillations produced by the moving parts of the compression assembly are not directly introduced into the housing and transmitted by the housing into other components of the vehicle.

The smooth running of the displacement machine is significantly improved in this way. An additional positive effect of this configuration lies in the fact that decoupling the compression assembly from the housing simplifies the maintenance of the compression assembly. In particular, the entire compression assembly can be exchanged comparatively easily.

Nonmetallic decoupling elements are preferably arranged between the compression assembly and the housing. In particular, the decoupling elements can be designed as O-rings. It is advantageous for the O-rings to consist of plastic and/or rubber. The decoupling elements bring about an oscillation decoupling between the compression assembly and the housing in an especially simple and cost-effective manner.

In general, it can be provided that the compression assembly be mechanically independently functional. Therefore, the compression assembly comprises all moving parts of the displacement machine. This ensures that the mechanical components that generate oscillations are effectively decoupled from the housing in terms of oscillation. The oscillations generated in the compression assembly are thus not transmitted directly to the housing. The smooth running is improved as a result. In particular, the outward transmission of oscillations to other parts, for example of a vehicle, is avoided.

In a preferred embodiment of the displacement machine according to the invention, the bearing plate forms an inner housing, in which the electric motor is arranged. Consequently, the bearing plate is not only designed like a flat plate, but is shaped like a housing. The bearing plate here preferably forms an inner housing, which is arranged inside of the housing as part of the compression assembly, and decoupled from the latter in terms of oscillation. As a result of the inner housing, the moving parts of the compression assembly are combined, and form a uniformly manageable structural unit.

The bearing plate can have a one-part or multipart design. A one-part configuration of the bearing plate has advantages during assembly. In particular, fewer individual parts need to be manufactured, which can reduce production costs. A multipart design of the bearing plate increases flexibility during maintenance or repair of the displacement machine.

The bearing plate, in particular the inner housing, can carry a shaft bearing of the motor shaft. The motor shaft is thus mounted in the bearing plate. Consequently, the motor shaft is part of the compression assembly, and thus decoupled from the housing in terms of oscillation.

The bearing plate can fixedly connect the electric motor, in particular its stator, the shaft bearing and the counterspiral. In this regard, the bearing plate forms a central component of the compression assembly. Specifically, the bearing plate can form a connecting link between the movable parts of the compression assembly.

A preferred variant of the invention provides that the shaft bearing be designed in such a way that the motor shaft is supported exclusively via the single shaft bearing. In conventional scroll compressors, the motor shaft is most often supported against the bearing plate via a first bearing on the one hand, and against the floor of the housing via a second bearing on the other. In order to avoid any metallic contact between the compression assembly and the housing, however, it is advantageous to do without the second bearing. As a consequence, there is no direct oscillation-transmitting connection between the motor shaft and the housing. A transmission of structure-borne sound is thus further avoided.

In order to be able to absorb the forces arising in the motor shaft even given a one-sided bearing, it is preferred that the shaft bearing be designed as a double-rowed angular contact ball bearing or as a pair of mutually abutting single-rowed angular contact ball bearings. The double-rowed angular contact ball bearing or the pair of mutually abutting single-rowed angular contact ball bearings can each have a U-arrangement. In this way, axial forces acting on the motor shaft are also readily absorbed by the shaft bearing.

It can further be provided that the compression assembly, in particular the bearing plate, comprises materials other than the housing. In particular, the bearing plate can be formed of a material differing from the housing. This makes it possible to achieve and further improve a functional separation. The housing has the function of protecting the compression assembly against outside influences. To this end, the housing is preferably made out of a corrosion-resistant material, preferably aluminum. The compression assembly, in particular the bearing plate, forms the mechanical components required for operations involving the basic function of the displacement machine. Forces are released in the process, which must be absorbed via the components of the compression assembly. In particular the bearing plate must absorb high forces. In this regard, it is advantageous that the bearing plate be made out of a strong material, for example a steel. It is especially preferred that the bearing plate and the shaft bearing have a material with a similar heat expansion coefficient, in particular the same heat expansion coefficient. This prevents a tensioning of the shaft bearing in the bearing plate, and additionally ensures that vibrations are avoided.

The invention will be described below based on an exemplary embodiment with reference to the attached drawing. The sole FIGURE therein shows a longitudinal sectional view through a displacement machine according to the invention.

### DETAILED DESCRIPTION

The sole FIGURE shows a displacement machine according to the spiral principle, in particular a scroll compressor. The scroll compressor has a housing 100, which encloses a compression assembly 150. In the exemplary embodiment shown here, the housing 100 consists of a primary housing 110 and a housing cover 120. The primary housing 110 is essentially pot-shaped in design, and sealed at an axial end by the housing cover 120.

The compression assembly 150 comprises an electric motor 10, which has a stator 13 and a rotor 11. The rotor 11 is torsionally locked with a motor shaft 12, which is mounted in a shaft bearing 31. The shaft bearing 31 is preferably configured as a double-rowed angular contact ball bearing, and forms the only bearing for the motor shaft 12. Alternatively, the shaft bearing 31 can also be formed by a pair of mutually abutting, single-rowed angular contact ball bearings. In any event, the shaft bearing 31 preferably has an O-arrangement, so that it can absorb axial forces in both directions.

The shaft bearing 31 is preferably the only shaft bearing 31. Specifically, the motor shaft 12 is only mounted via the single shaft bearing 31. The motor shaft 12 has no bearing or is unmounted in particular on a side lying opposite the single shaft bearing 31. In this regard, the motor shaft 12 is cantilever mounted via the single shaft bearing 31. In this conjunction, reference is made to an overhung mounting of the motor shaft 12.

The motor shaft 12 is further spaced a distance apart from a housing floor 101 of the housing 100. In particular, there exists no direct contact between the motor shaft 12 and the housing floor 101. This prevents vibrations from being transmitted into the housing 100 by the rotational movement of the motor shaft 12. An inverter housing can further be arranged on the housing floor 101. The housing floor 101 can also form a wall of the inverter housing. In both cases, the inner space of the inverter housing forms a resonance space or resonance body, which can amplify sound emissions. Because the motor shaft 12 is decoupled from the housing floor 101, and hence from the inverter housing, these types of sound emissions are reduced.

The shaft bearing 31 is pressed into a bearing plate 30. The bearing plate 30 separates a drive chamber of the compression assembly 150 from a compression chamber. An electric motor 10 is arranged in the drive chamber. The compression chamber comprises a displacement spiral 21, which rests on the bearing plate 30 or a sliding plate (not shown) arranged on the bearing plate 30. The displacement spiral 21 engages into a counterspiral 22, which likewise is arranged in the compression chamber. The counterspiral 22 is firmly connected, in particular screwed, with the bearing plate 30.

In order to achieve a good seal between the displacement spiral 21 and the bearing plate 30, the displacement spiral 21 has a sealing groove 23. The sealing groove 23 preferably extends annularly around the longitudinal axis of the motor shaft 12 through the floor of the displacement spiral 21. The sealing groove 23 incorporates a seal, which is not shown on the figure for reasons of clarity.

An anti-rotation mechanism 40 is provided radially inside of the sealing groove 23. The anti-rotation mechanism 40 comprises several distributed pins 41, which are fixedly arranged in the bearing plate 30. The pins 41 protrude over the bearing plate 30, and engage into boreholes 42 formed in the displacement spiral 21. The boreholes 42 have a cross sectional diameter that is clearly greater, in particular many times greater, than the diameter of the pins. The anti-rotation mechanism 40, which is also referred to as a pin/ring mechanism, prevents the displacement spiral 21 from turning around its center axis. In this way, the displacement spiral is instead forced into an orbiting motion. The displacement spiral 21 is here driven by the motor shaft 12, which is in contact with the displacement spiral 21 via a compensation mechanism 14 and an eccentric bearing 15. The compensation mechanism 14 essentially comprises a counterweight, which compensates for dynamic imbalances of the displacement spiral 21, thereby causing the compression chambers between the displacement spiral 21 and the counterspiral 22 to be sealed.

As evident from the figure, the bearing plate 30 forms an inner housing 32, in which the electric motor 10 is arranged. In particular, the bearing plate 30 continues cylindrically, and receives the stator 13 of the electric motor 10. The stator 13 is preferably fixedly connected with the inner housing 32. The inner housing 32 has several grooves 33, which preferably extend annularly around the longitudinal axis of the motor shaft 12. A total of four grooves 33 are provided, wherein three grooves 33 are outwardly radially open, while one groove 33 is open in the direction of the axial end of the inner housing 32. Decoupling elements 34 are arranged in all grooves 33, and are in contact with the housing 100. The decoupling elements 34 are preferably designed as O-rings made of plastic and/or rubber.

The inner housing 32 has a clearance to the housing 100. It is specifically provided that a gap exist between the inner housing 32 and the housing 100. The decoupling elements 34 bridge this gap, and space the inner housing 32 a distance from the housing 100. As a result, there is no metallic contact between the inner housing 32 and the housing 100, so that a sound decoupling is achieved.

The counterspiral 22 likewise has grooves 33, which each receive a decoupling element 34. The counterspiral 22 together with the inner housing 32 and the components arranged in the inner housing 32 form the compression assembly 150, which is mounted completely sound decoupled from the housing 100.

Mounting takes places via the decoupling elements 34, which are arranged in the grooves 33.

As also evident on the figure, one of the grooves 33 in the counterspiral 22 is open in the direction of a free axial end of the housing cover 120. The axially open groove 33 of the inner housing 32 is open in the opposite direction, i.e., in the direction of the free end of the primary housing 110. This ensures that the compression assembly 150 is decoupled from the housing 100 not just radially, but also axially on both sides. The second groove 33 is open radially outward in the counterspiral 22, i.e., in the direction of the inner surface of the housing cover 120.

As further evident from the figure, the compression assembly 150 is in itself mechanically independent. All mechanical processes of the scroll compressor thus take place in the compression assembly 150. The sole task of the housing 100 is to form the corresponding fluid chambers for guiding the working fluid to be compressed and protect the compression assembly 150 against external environmental influences.

### REFERENCE NUMBERS

10 Electric motor
11 Rotor
12 Motor shaft
14 Stator
15 Compensation mechanism
21 Displacement spiral
22 Counterspiral
23 Sealing groove
30 Bearing plate
31 Shaft bearing
32 Inner housing
33 Groove
34 Decoupling element
40 Anti-rotation mechanism
41 Pin
42 Borehole
100 Housing
101 Housing floor
110 Primary housing
120 Housing cover
150 Compression assembly

1. A displacement machine according to the spiral principle, in particular a scroll compressor, with a housing and a compression assembly, which has an electric motor, an orbiting displacement spiral, a counterspiral and a bearing plate, wherein the displacement spiral and the counterspiral intermesh in such a way as to form variable compression chambers between the displacement spiral and the counterspiral, so as to receive and compress a working fluid flowing through a working fluid circuit, and wherein the electric motor is drive-connected with the displacement spiral by means of a motor shaft, wherein the compression assembly is decoupled from the housing in terms of oscillation, wherein the bearing plate forms an inner housing in which the electric motor is arranged.

2. The displacement machine according to claim 1, wherein nonmetallic decoupling elements, in particular O-rings, preferably made out of plastic and/or rubber, are arranged between the compression assembly and the housing.

3. The displacement machine according to claim 1, wherein the bearing plate has a one-part or multipart design.

4. The displacement machine according to claim 1, wherein the bearing plate, in particular the inner housing, carries a shaft bearing of the motor shaft.

5. The displacement machine according to claim 4, wherein-the bearing plate fixedly interconnects the electric motor, in particular its stator, the shaft bearing and the counterspiral.

6. The displacement machine according to claim 1, wherein the shaft bearing is designed in such a way that the motor shaft is supported exclusively via the single shaft bearing.

7. The displacement machine according to claim 6, wherein the shaft bearing is designed as a double-rowed angular contact ball bearing or as a pair of mutually abutting single-rowed angular contact ball bearings in an O-arrangement.

8. The displacement machine according to claim 1, preceding wherein the compression assembly, in particular the bearing plate, comprises materials other than the housing or is formed therefrom.

9. The displacement machine according to claim 1, wherein the housing comprises a corrosion-resistant material, in particular aluminum or is formed therefrom.
